(19) United States
(12) Patent Application Publication
(10) Pub. No.: US 2024/0131376 A1
(43) Pub. Date: Apr. 25, 2024

(54) ELECTRONICALLY ACTIVATED SPRINKLER INTERLOCK

(71) Applicant: Tyco Fire Products LP, Cranston, RI (US)

(72) Inventor: Ian M. Jutras, Sharon, MA (US)

(73) Assignee: Tyco Fire Products LP, Cranston, RI (US)

(21) Appl. No.: 18/547,558

(22) PCT Filed: May 9, 2022
(86) PCT No.: PCT/IB2022/054301

§ 371 Date: Aug. 22, 2023

Related U.S. Application Data
(60) Provisional application No. 63/186,299, filed on May 10, 2021.

(51) Int. Cl. A62C 37/40

(52) U.S. Cl. CPC A62C 37/40

(57) ABSTRACT

Fire suppression systems and methods are provided. The system can include an electronically activated sprinkler (EAS) interlock system to protect a target zone. The EAS interlock system can include a controller. The controller can be communicably coupled with a first detector and a second detector. The first detector can be disposed in an area outside the target zone. The second detector can be disposed inside the target zone. The controller can receive an input signal from the first detector indicating an event occurred prior to or in an absence of receipt of an input signal from the second detector. The controller can provide a hold command to at least temporarily inhibit a sprinkler inside the target zone from actuation based on receipt of the input signal from the first detector prior to or in the absence of receipt of the input signal from the second detector.

### CROSS-REFERENCE TO RELATED APPLICATIONS

This application claims the benefit of U.S. Provisional Application No. 63/186,299, filed May 10, 2021, which is incorporated herein by reference in its entirety.

### BACKGROUND

Fire protection systems for storage occupancies can be used to protect stored commodities. Fire protection systems can include automatic sprinklers.

### SUMMARY

At least one aspect is directed to a fire suppression system. The system can include an electronically activated sprinkler (EAS) interlock system to protect a target zone. The EAS interlock system can include a controller communicably coupled with a first detector and a second detector. The first detector can be disposed in an area outside a target zone. The second detector can be disposed inside the target zone. The controller can receive an input signal from the first detector indicating an event occurred prior to or in an absence of receipt of an input signal from the second detector indicating the event occurred. The controller can provide, responsive to receipt of the input signal from the first detector indicating the event occurred, a hold command to at least temporarily inhibit a sprinkler inside the target zone from actuation based on receipt of the input signal from the first detector prior to or in the absence of receipt of the input signal from the second detector.

At least one aspect is directed to a fire suppression method. The method can include receiving, by a controller, an input signal from a first detector indicating an event occurred prior to or in an absence of an input signal from a second detector indicating the event occurred. The method can include providing, by the controller, a hold command to at least temporarily inhibit a sprinkler disposed inside the target zone from actuation based on receipt of the input signal from the first detector prior to or in the absence of the input signal from the second detector.

At least one aspect is directed to a fire suppression system. The fire suppression system can include an electronically activated sprinkler (EAS) interlock system to protect a target zone. The EAS interlock system can include a first sprinkler connected with piping. The first sprinkler can be disposed in the target zone. The EAS interlock system can include a first detector disposed in an area outside the target zone. The EAS interlock system can include a second detector disposed in the target zone. The second detector can be communicably coupled with the first sprinkler. The fire suppression system can include a non-electronically activated sprinkler (non-EAS) system to protect the area outside the target zone. The non-EAS system can include a second sprinkler connected with the piping. The second sprinkler can be disposed in the area outside the target zone. The fire suppression system can include a barrier to define a perimeter of the target zone. The fire suppression system can include a controller. The controller communicably coupled with the first detector and the second detector. The controller can receive an input signal from the first detector indicating an event occurred prior to or in an absence of receipt of an input signal from the second detector indicating the event occurred. The controller can provide, responsive to receipt of the input signal from the first detector indicating the event occurred, a hold command to at least temporarily inhibit the first sprinkler from actuation based on receipt of the input signal from the first detector prior to or in the absence of receipt of the input signal from the second detector.

At least one aspect is directed to fire suppression system. The fire suppression system can include an electronically activated sprinkler (EAS) interlock system to protect a target zone. The EAS interlock system can include a sprinkler connected with piping. The sprinkler can be disposed in the target zone. The EAS interlock system can include a controller. The controller can be communicably coupled with a first detector, a second detector, and a third detector. The first detector can be disposed in the target zone. The second detector can be disposed in the target zone. The third detector can be disposed in an area outside the target zone. The controller can receive an input signal from the first detector indicating an event occurred. The controller can receive an input signal from the second detector indicating the event occurred after receiving an input signal from the first detector indicating the event occurred and prior to or in an absence of receipt of an input signal from the third detector indicating the event occurred. The controller can provide, responsive to receipt of the input signal from the second detector indicating the event occurred, an actuation command to actuate the sprinkler based on receipt of the input signal from the second detector prior to or in the absence of receipt of the input signal from the third detector.

At least one aspect is directed to a fire suppression system. The fire suppression system can include an electronically activated sprinkler (EAS) interlock system to protect a target zone. The EAS interlock system can include a controller. The controller can be communicably coupled with a first detector and a second detector. The first detector can be disposed inside a target zone. The second detector can be disposed in an area outside the target zone. The controller can receive an input signal from the first detector indicating an event occurred prior to or in an absence of receipt of an input signal from the second detector indicating the event occurred. The controller can provide, responsive to receipt of the input signal from the first detector indicating the event occurred, an actuation command to actuate a sprinkler inside the target zone based on receipt of the input signal from the first detector prior to or in the absence of receipt of the input signal from the second detector.

These and other aspects and implementations are discussed in detail below. The foregoing information and the following detailed description include illustrative examples of various aspects and implementations, and provide an overview or framework for understanding the nature and character of the claimed aspects and implementations. The drawings provide illustration and a further understanding of the various aspects and implementations, and are incorporated in and constitute a part of this specification.

### BRIEF DESCRIPTION OF THE DRAWINGS

The accompanying drawings are not intended to be drawn to scale. Like reference numbers and designations in the various drawings indicate like elements. For purposes of clarity, not every component can be labeled in every drawing. In the drawings:

FIG. 1 depicts an example sprinkler system.

FIG. 2 depicts a top view of an example fire suppression system.

FIG. 3 depicts an elevation view of an example fire suppression system.

FIG. 4 depicts a schematic illustration of an example controller for use in a fire suppression system.

FIG. 5 is a flow diagram depicting an example fire suppression method.

FIG. 6 is a flow diagram depicting an example fire suppression method.

### DETAILED DESCRIPTION

Following below are more detailed descriptions of various concepts related to, and implementations of, methods, apparatuses, and systems of storage rack protection. The various concepts introduced above and discussed in greater detail below may be implemented in any of numerous ways.

The present disclosure generally relates to a fire suppression system. More particularly, the present disclosure relates to a fire suppression system that includes interlocking separate systems so that one can actuate to the realization of an event occurring while another one remains inactive. Actuating certain systems while keeping other systems inactive ensures adequate pressure within the system to provide proper protection where it is needed. Fire suppression systems generally include sprinklers which are configured to inhibit or permit flow of fluid (typically water, but also in some applications fire suppressant fluid) depending upon conditions. Fire suppression systems are used in various environments, including but not limited to, residences, schools, warehouses, factories, and stores. In the instance of a fire, the sprinklers are configured to permit the flow of fluid such that the fluid may be dispersed to subdue or prevent the spread of fire within a given area.

The system described herein can include various configurations. The system interlocks different fire suppression systems that are within the same general area or occupancy in order to control which system actuates when an event occurs. The system that is to actuate is determined by, in part, which detectors detect an event and send a signal and the order in which the signals are received. A system can be told to actuate or to hold based on the signals received and the corresponding order in which those signals are received. Once a system receives a command, the system can reset to its original state once certain thresholds are met or actions are taken.

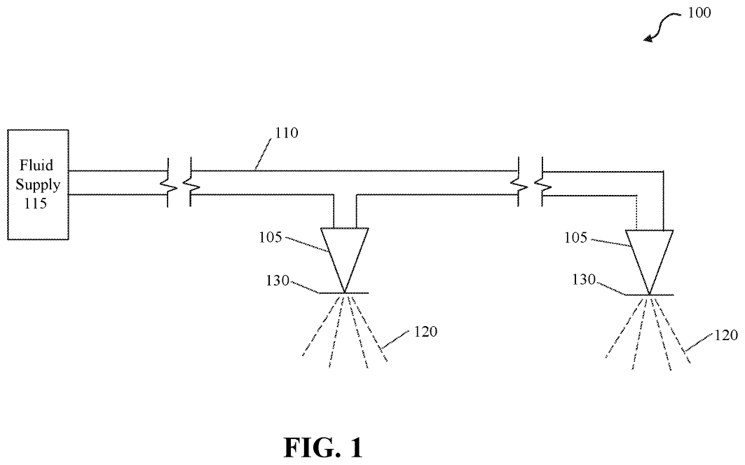

FIG. 1 depicts a sprinkler system 100. The sprinkler system 100 can distribute at least one fire suppressant fluid 120 onto or nearby a fire, extinguishing the fire and preventing the fire from spreading. The sprinkler system 100 can be used to protect, among others, a storage rack assembly in a warehouse. The sprinkler system 100 can be used alone or in conjunction with other types of fire suppression systems (e.g., other building sprinkler systems, a handheld fire extinguisher). The sprinkler system 100 can be used with a variety of fire suppressant fluids 120, including but not limited to water (e.g., powders, liquids, foams, or other fluid or flowable materials).

The sprinkler system 100 can include at least one sprinkler 105, piping 110 (e.g., one or more pipes, tubes, conduits), and at least one fluid supply 115. The sprinkler 105 can be mounted on or connected with piping 110 and can be any kind of sprinkler (e.g., electronically activated sprinkler (EAS), early suppression fast response (ESFR) sprinkler, extended coverage (EC) sprinkler, control mode density area (CMDA) sprinkler, control mode specific application (CMSA) sprinkler). The piping 110 can include one or more main pipes, connected with the fluid supply 115, from which one or more branch lines extend. The piping 110 can be fluidly coupled with one or more sprinklers 105. The sprinklers 105 can receive water or other fire suppressant fluids 120 from the fluid supply 115 via the piping 110. The sprinklers 105 each define one or more outlets, through which the fire suppressant fluid 120 can exit and contact at least one deflector 130 to form a spray of water or other fire suppressant fluid 120 that covers a desired area. The fire suppressant fluid 120 from the sprinklers 105 then suppress or extinguish fire within that area.

The sprinklers 105 can be either electronically activated sprinklers (EAS) or non-electronically activated sprinklers (non-EAS). A non-EAS can, for example, include at least one activation element (e.g., thermal element). The activation element can change from a first state that prevents fluid flow out of the sprinkler 105 to a second state that permits fluid flow out of the sprinkler 105 responsive to a fire condition. For example, the activation element can include a glass bulb including a fluid that expands responsive to an increase in temperature (e.g., responsive to heat provided to the fluid from a fire), such as to cause the glass bulb to break responsive to the temperature meeting or exceeding a threshold temperature; the activation element can include a fusible link that includes two or more pieces coupled using a solder that can melt responsive to the temperature meeting or exceeding a threshold temperature. An EAS can, for example, be directly or indirectly coupled with a controller to control fluid discharge and distribution. For example, the EAS can include a sealing assembly supported in place by a removable structure. The controller can provide an electrical pulse or signal to an actuator coupled with the EAS to displace (e.g., break, fracture, eject) the removable structure and the sealing assembly to permit fluid discharge.

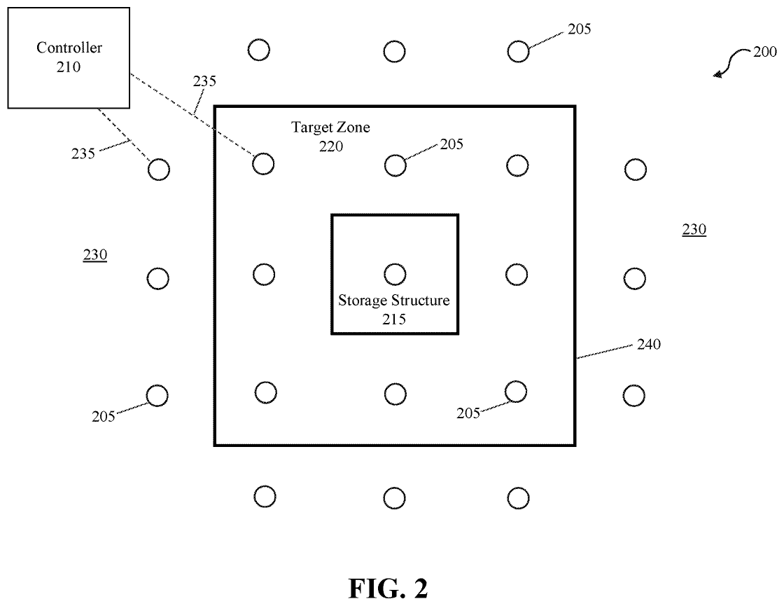

FIG. 2 depicts a fire suppression system 200. Fire suppression system 200 can include at least one sprinkler system 100, at least one detector 205, and at least one controller 210. The fire suppression system 200 can be used to protect at least one storage structure 215. The storage structure 215 can include densely packed storage structures (e.g., double-deep rack, push-back rack, pallet flow rack). The storage structure 215 can include rack arrangements (e.g., single-row racks, multi-row racks) and non-rack storage systems including, for example, palletized, solid-piled (stacked commodities), bin box (storage in five-sided boxes with little to no space between boxes), shelf (storage on structures up to and including thirty inches deep and separated by aisles of at least thirty inches wide) or back-to-back shelf storage (two shelves separated by a vertical barrier with no longitudinal flue space and maximum storage height of fifteen feet).

The storage structure 215 can further include an automated storage and retrieval system (ASRS). The ASRS can be any of a number of automated storage and retrieval systems. For example, the ASRS can be a vertical carousel, horizontal carousel, vertical lift module, etc. The ASRS can be a high-piled storage system (in excess of twelve feet (12 ft)). The ASRS can be a densely packed structure comprising shafts and tracks for a computer implemented retrieval system to retrieve items or bins located throughout the structure.

The stored commodity in the storage structure 215 can include any one of NFPA-13 defined Class I, II, III or IV commodities, alternatively Group A, Group B, or Group C plastics, elastomers, and rubbers, or further in the alternative any type of commodity capable of having its combustion behavior characterized. With regard to the protection of Group A plastics, the systems and methods can be configured for the protection of expanded and exposed plastics. According to NFPA 13, Sec. 3.9.1.13, “Expanded (Foamed or Cellular) Plastics” is defined as “[t] hose plastics, the density of which is reduced by the presence of numerous small cavities (cells), interconnecting or not, disposed throughout the mass.” Section 3.9.1.14 of NFPA 13 defines “Exposed Group A Plastic Commodities” as “[t] hose plastics not in packaging or coverings that absorb water or otherwise appreciably retard the burning hazard.”

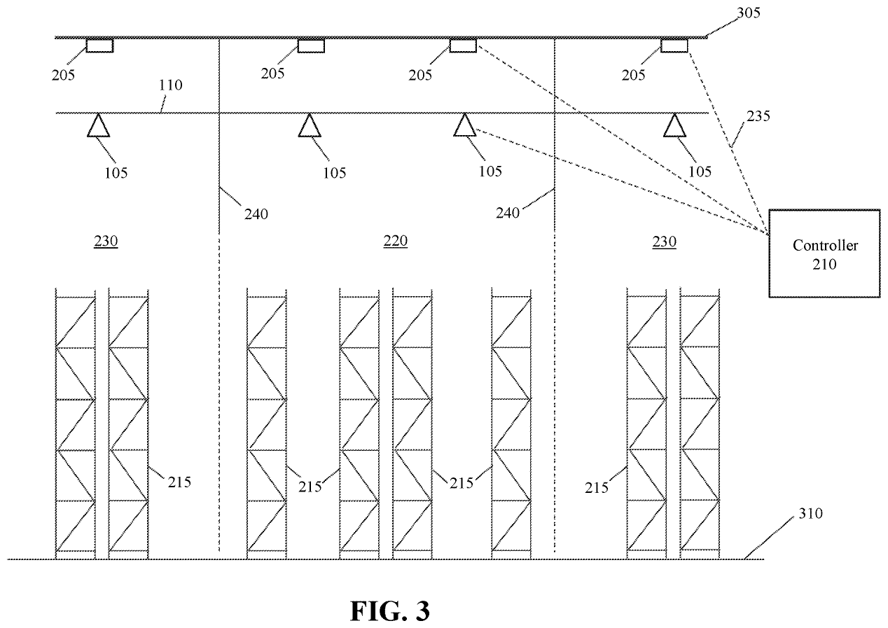

In fire suppression system 200, the sprinklers 105 can be installed between the ceiling and the tops of the storage structures 215 as shown in FIG. 3, among others. The sprinklers 105 can be mounted or connected with the piping 110. A portion of the piping 110 can be suspended beneath the ceiling of the occupancy and above the storage structure 215 to be protected. The sprinklers 105 can be electronically activated sprinklers (EAS) that are electronically coupled with the detector 205 or the controller 210. The electronic coupling can be a wired or wireless connection. For example, the sprinkler 105 can be wired to a detector 205 to receive an actuation signal. In another example, the sprinkler 105 can be wirelessly connected (e.g., network connection, Bluetooth) to the controller 210 to receive an actuation signal. The sprinklers 105 can also be non-electronically activated sprinklers (non-EAS) that automatically actuate (without the direction of a controller) when a certain threshold is reached. For example, a non-EAS can actuate when a temperature around the sprinkler 105 reaches a certain threshold temperature that causes an activation element to change from a first state that prevents fluid flow to a second state that permits fluid flow (e.g., the activation element melts). The sprinklers 105 can be aligned with or coupled with the detectors 205, or the sprinklers 105 can be positioned offset from the detectors 205 in an orientation sufficient to provide adequate protection to the desired protected area. For example, sprinklers 105 can be disposed below, but remain axially aligned with the detectors 205 (as depicted in FIG. 3, among others), or the sprinklers 105 can be disposed at the same elevation, but offset from the detectors 205. Alternatively, the sprinklers 105 and the detectors 205 can make up one structural element.

The detector 205 can be positioned near the storage structure 215 to monitor the space to detect changes for any one of temperature, thermal energy, spectral energy, smoke, and any other parameter to indicate the presence of a fire in the space. With more than one detector 205, the detectors 205 can be arranged in a cross-zone detection orientation. For example, the detectors 205 can be separated into zones. A first zone can be a target zone 220, with a first detector 205, and a second zone can be an area outside the target zone 230, with a second detector 205. The detectors 205 disposed in the target zone 220 can be the same type of detectors 205 as those disposed in the area outside the target zone 230, or they can be different. For example, the detectors 205 inside the target zone can detect smoke, while the detectors 205 in the area outside the target zone 230 can detect rate of heat rise, among other variations. Conversely, all detectors 205 can be a single type of detector (e.g., all smoke detectors). Detectors 205 can be disposed proximate to the sprinklers 105, as well as below and proximate a ceiling. The detectors 205 are communicably coupled with the controller 210 to communicate detection data or signals to the controller 210 of the fire suppression system 200 for processing as described herein. The ability of the detectors to monitor environmental changes indicative of a fire can depend upon the type of detector being used, the sensitivity of the detector, coverage area of the detector, or the distance between the detector and the fire origin. Accordingly, the detectors 205 individually and collectively are appropriately mounted, spaced, or oriented to monitor the occupancy for the conditions of a fire in a manner described.

The detectors 205 can provide a detection signal based on determining a threshold moment in fire growth. The threshold moment in fire growth can be a particular temperature (e.g., 135° F.), a rate of rise in temperature (e.g., 10° F./min), etc. The detection signal can be transmitted to the controller 210 by at least one connection 235. The detection signal can be an analog signal, digital signal, fiber optic signal, etc. The connection 235 can be any one or more of wired and wireless communication. The detector 205 can receive a command from the controller 210 and relay the command to a sprinkler 105. The command can also bypass the detector 205 and be transmitted directly from the controller 210 to the sprinkler 105 (e.g., the controller 210 can also have a connection 235 with the sprinkler 105).

The target zone 220 can include a sprinkler 105, a storage structure 215, a detector 205, and a perimeter. The perimeter can be defined by at least one barrier 240. The barrier 240 can be, for example, a draft curtain protruding downward from the ceiling to channel or prevent the migration of smoke or heat between zones. The barrier 240 can be a solid, fixed obstruction or a deployable barrier having a fixed length during its operation. For example, the barrier 240 can be a cement or metal obstruction permanently coupled with a ceiling. The barrier 240 can also be a movable structure configured to maintain an open configuration during operation and a closed configuration when not in operation (e.g., a curtain slidable along a track). The area outside the target zone 230 can include a sprinkler 105 and a detector 205. The area outside the target zone 230 can include any area outside the perimeter of the target zone 220. The sprinkler 105 disposed inside the target zone 220 can be an EAS sprinkler controlled by controller 210. The sprinkler 105 disposed in the area outside the target zone 230 can also be an EAS sprinkler, but can also be a different kind of sprinkler (e.g., ESFR, EC) not controlled by the controller 210.

FIG. 3 depicts an elevation view of fire suppression system 200. The detectors 205 can be disposed beneath ceiling 305 and above, or in line with, the sprinklers 105. The detectors, for example, can be disposed a distance of zero to six inches beneath the ceiling 305. The sprinklers, for example, can be disposed below the detectors a distance of zero to thirty six inches. The detectors 205 can be aligned axially with the sprinklers 105 (as depicted), or the sprinklers 105 can be off-set from the detectors 205 a distance ranging, for example, from zero inches to eighteen inches. The barrier 240 can extend downward from the ceiling 305 a distance of at least twelve inches, or at least a distance that extends below the detectors 205. The barrier 240 is meant to prevent heat and smoke from migrating from one zone to another for at least a time long enough to determine where a fire originates. The barrier 240 separates the detectors 205 and the sprinklers 105 in the target zone 220 from the detectors 205 and the sprinklers 105 in the area outside the target zone 230. The barrier 240 does not extend the whole distance from the ceiling 305 to a floor 310, but everything disposed inside the perimeter (as seen from the top view in FIG. 2) is considered within the target zone 220 including, for example, the storage structure 215. There can be several storage structures 215 disposed in the target zone 220 and organized in any variety of arrangements. Similarly, the area outside the target zone 230 can also include any number of storage structures 215 organized in any variety of arrangements.

The controller 210 communicably coupled with the detectors 205 and the sprinklers 105 (either directly or indirectly) are connected via connection 235. Connection 235 can facilitate any one or more of wired or wireless communication. For example, connection 235 can be a physical wire connecting detector 205 to controller 210. The controller 210 can be a control panel in the same building as the fire suppression system 200. Connection 235 can also be a wireless connection with the controller 210 able to communicate with detector 205 via a network. The controller 210 can be located anywhere as long as connection 235 maintains intact. For example, the controller 210 can be onsite as a control panel, and can be in the same occupancy as the fire suppression system 200 or in another room in the same building. The controller 210 an also be remote. For example, the controller 210 can be a control panel or a server at a different location.

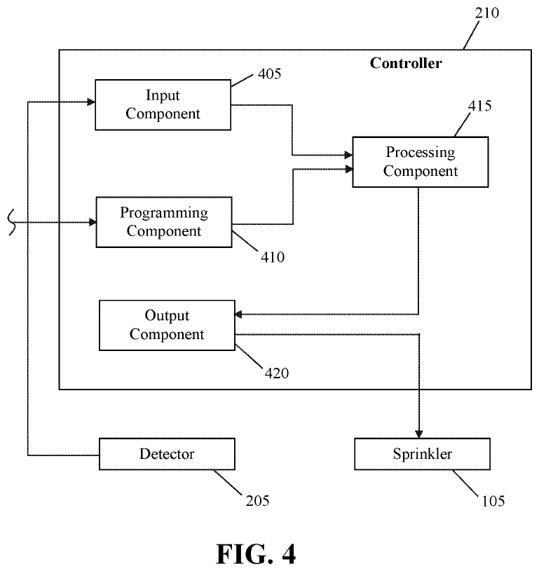

As depicted in FIG. 4, among others, the controller 210 can be structured for receiving, processing, and generating the various input and output signals from or to each of the detectors 205 and sprinklers 105. Functionally, the preferred controller 210 includes at least one input component 405, at least one programming component 410, at least one processing component 415 and at least one output component 420. The input component 405 can receive detection data or input signals from the detectors 205. The detection data or signals can include, for example, either raw detector data or calibrated data, such as for example, any one of continuous or intermittent temperature data, spectral energy data, smoke data or the raw electrical signals representing such parameters, e.g., voltage, current or digital signal, that would indicate a measured environmental parameter of the occupancy. Additional data parameters collected from the detectors 205 can include time data, address, or location data of the detector 205. The programming component 410 can provide for input of user defined parameters, criteria, or rules that can define detection of a fire, the location of the fire, the profile of the fire, the magnitude of the fire, or a threshold moment in the fire growth. Moreover, the programming component 410 can provide for input of select or user-defined parameters, criteria, or rules to identify sprinklers 105 for operation in response to the detected fire, including one or more of the following: defining relations between sprinklers 105 (e.g., proximity, adjacency, etc.), defining limits on the number of devices to be operated (i.e., maximum and minimums, the time of operation, the sequence of operation, pattern or geometry of devices for operation, their rate of discharge), or defining associations or relations to detectors. For example, the programming component 410 can include instructions telling the controller 210 to inhibit certain sprinklers from activation upon receipt of a signal from a certain detector. As provided in the control methodologies described herein, detectors 205 including, but not limited to, temperature sensors or smoke detectors, can be associated with sprinklers 105 (EAS) on a one-to-one basis or alternatively detectors 205 can be associated with more than one sprinkler 105. For example, detection of an event by a single detector 205 can lead to actuation of one associated sprinkler 105 (e.g., sprinkler communicably connected to the detector). Alternatively, detection of an event by a single detector 205 can lead to actuation of more than one associated sprinkler 105. Contrastingly, more than one detector 205 can control the actuation of a single sprinkler 105. For example, a sprinkler 105 can actuate only when a first detector 205 and a second detector 205 detect an event.

Accordingly, the processing component 415 can process the input and parameters from the input component 405 and programming component 410 to detect and locate a fire, and select, prioritize, or identify the sprinklers 105 for controlled operation in a preferred manner. For example, the processing component 415 can determine when a threshold moment is achieved. The output component 420 of the controller 210 can generate appropriate signals to control operation of the identified sprinklers 105 in accordance with one or more methodologies described herein. The programming may be hard wired or logically programmed and the signals between system components can be one or more of analog, digital, or fiber optic data. Moreover communication between components, for example connections 235, of the fire suppression system 200 can be any one or more of wired or wireless communication.

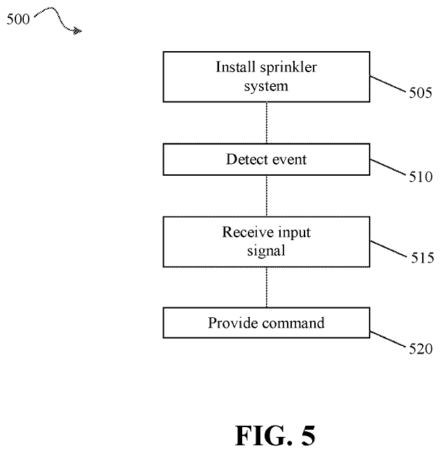

FIG. 5 depicts a flow diagram of a fire suppression method 500 of the fire suppression system 200. The method of fire suppression 500 can include installing at least one sprinkler system 505, detecting at least one event 510, receiving at least one input signal 515, and providing at least one command 520. Act 505 of installing a sprinkler system can include installing an EAS sprinkler system inside a target zone 220 to protect a designated storage structure 215. Installing can include retrofitting an already existing system (e.g., adding, moving, or adjusting sprinklers and/or using or rearranging already existing pipe) or providing a completely new system (e.g., providing all new piping and sprinklers). Installing can also include interlocking multiple sprinkler systems with controller 210 so controller 210 can control the systems according to the methods described herein. Interlocking can mean linking or connecting different fire suppression systems or sprinkler systems together, or system elements together, so that the actions taken in one system can dictate or affect the actions taken in another.

Detecting an event at act 510 can include a detector 205 (e.g., smoke detector, fixed temperature heat detector, rate of rise detector) detecting a fire by sensing a threshold moment indicative of a fire (e.g., temperature above 155° F., rate of heat rise above 20° F./min).

Receiving an input signal at act 515 can include the controller 210 receiving an input signal from the detector 205 of the fire suppression system 200 indicating the detection of the event. The controller 210 can receive the input signal from a detector 205 indicating the event occurred prior to or in the absence of receiving another input signal from another detector 205. For example, if controller 210 receives a signal from detector 205 disposed in the area outside the target zone 230, the controller 210 can receive a subsequent signal from detector 205 disposed inside the target zone 220. Alternatively, controller 210 can never receive a signal from the detector 205 inside the target zone 220.

Act 515 can also include the controller 210 processing the input signal via the processing component 415 to determine the presence of a fire based on receiving a threshold moment in fire growth signal. The threshold moment in fire growth can be based on a sudden change in the sensed data from the detectors, such as for example, a sudden increase in temperature, spectral energy, or other measured parameters. The threshold moment in fire growth can be a rate of temperature increase (e.g., 20° F./min) sensed by the detector 205. A threshold rate of temperature increase can be a predetermined rate of temperature increase as set by an operator. The threshold moment in fire growth can also be a particular temperature (e.g., 155° F.) sensed by the detector 205. The threshold temperature can be a predetermined temperature as set by an operator. The threshold moment in fire growth can be a determination of fire from the detector 205. The threshold moment in fire growth can be determined by a combination of the instantaneous temperature and the rate of temperature rise. The threshold moment in fire growth can be determined by a rolling average of the instantaneous temperature or rate of temperature rise being greater than a determined threshold.

Act 515 can also include the controller 210 determining the origination of the signal received (e.g., the signal came from the detector 205 inside the target zone 220 or the detector 205 in the area outside the target zone 230). Providing a command at act 520 can depend, in part, on where the input signal originated. For example, if the detector 205 that detected the event and sent the input signal is in the target zone 220, it is likely that the detected event is in the target zone 220 and the sprinklers 105 in the target zone 220 should actuate. Alternatively, if the detector 205 that detected the event and sent the input signal is in the area outside the target zone 230, it is likely that the detected event is in the area outside the target zone 230 and the sprinklers 105 in the area outside the target zone 230 should actuate. If the sprinklers 105 are non-EAS, the sprinklers 105 can, for example, actuate when the activation element of each sprinkler 105 is triggered. If the sprinklers 105 are EAS, the controller 210 can control which sprinklers 105 actuate and when those sprinklers 105 actuate. Which sprinklers 105 to actuate based on the origination of the signal received can be established by the predetermined instructions provided to the controller 210 via the programming component 410.

If more than one signal is received, act 515 can also include the controller 210 determining the order in which the signals were received. Again, providing a command at act 520 can depend, in part, on the order in which signals were received. For example, if the controller 210 receives a signal from the detector 205 in the target zone 220 before receiving a signal from the detector 205 in the area outside the target zone 230, this can indicate that the event is in the target zone 220 and the sprinklers 105 in the target zone 220 should actuate. Alternatively, if the controller 210 receives a signal from the detector 205 in the area outside the target zone 230 before receiving a signal from the detector 205 in the target zone 220, this can indicate that the event is in the area outside the target zone 230 and the sprinklers 105 in the area outside the target zone 230 should actuate. Again, which sprinklers actuate and when those sprinklers 105 actuate depend on the type of sprinkler (EAS or non-EAS). If the sprinklers 105 are EAS, which sprinklers 105 to actuate based on the order of the signals received can be established by the predetermined instructions provided to the controller 210 via the programming component 410.

Furthermore, providing the command at act 520 can also depend, in part, on the duration of time between receipt of the input signals. For example, if a second input signal is received less than ten seconds after receiving a first input signal, the first and second input signals originating from different zones, then the controller 210 can be programmed via the programming component 410 to send commands to actuate sprinklers 105 in both zones (if the sprinklers 105 in both zones are EAS). If the second input signal is received ten seconds or more after the first input signal, the controller 210 can be programmed to send a command to actuate only the sprinklers 105 disposed in the same area from which the first input signal was received (if the sprinklers 105 are EAS). The time between each input signal can be any length of time and can be a predetermined parameter input by an operator or programmer of the controller 210.

The barrier 240 (depicted in FIG. 3, among others) helps the fire suppression system 200 determine where the event originates by preventing or delaying the spread of heat or smoke between zones. For example, if a fire is in the area outside the target zone 230, the heat and smoke can rise to the ceiling 305 in the area outside the target zone 230. With the barrier 240 protruding down from the ceiling 305 and defining the perimeter of the target zone 220, the barrier 240 can block the heat and smoke at the ceiling 305, at least temporarily, from crossing that perimeter into the target zone 220. Therefore, the detectors 205 in the area outside the target zone 230 can detect the heat or smoke before the detectors 205 in the target zone 220. As described herein, fire suppression system 200 can operate with a minimal time differential between receipt of signals. Therefore, the barrier 240 does not need to completely prevent the migration of heat or smoke across this perimeter, but rather only delay the migration. Therefore, the barrier 240 can be constructed with a shorter depth than most other fire suppression systems require.

Act 515 can also include the controller 210 receiving two input signals from two different detectors 205 before sending a command at act 520. For example, the target area 220 can include a first detector 205 and a second detector 205. The controller 210 can receive an input signal from the first detector 205 indicating an event. The controller 210 can be programmed, via the programming component 410, to refrain from sending a command (e.g., an actuation command to actuate a sprinkler 105 in the target zone 220) until it receives a second input signal from the second detector 205 indicating the event. Waiting for the second input signal from the second detector 205 can prevent unnecessary actuation of the sprinklers 105 in the target zone 220. The second input signal can ensure that the fire is in the target area 220 before the sprinklers 105 in the target area 220 actuate. Once the controller 210 receives the second input signal from the second detector 205, the controller 210 can send an actuation command to actuate a sprinkler 105 in the target zone 220. In another example, if the controller 210 receives a second input signal from a detector 205 disposed in the area outside the target zone 230 before receiving a second input signal from a second detector 205 in the target zone, that can indicate that the fire is not in the target zone 220 and the controller 210 can be programmed to send a hold command to inhibit a sprinkler 105 in the target zone 220 from actuation. If the sprinkler 105 disposed in the area outside the target zone 230 is an EAS, the controller 210 can also be programmed to send an actuation command to actuate the sprinklers 105 disposed in the area outside the target zone 230.

In another example, act 515 can include the controller 210 receiving at least two input signals from detectors 205 disposed in the same zone before providing a command at act 520. For example, if controller 210 receives a first input signal from a first detector 205 disposed in the target zone 220 then a second signal from a second detector 205 disposed in the area outside the target zone 230, the controller 210 can be programmed to not provide a command until it receives a third input signal. If the third signal is from the target zone 220, the controller 210 can actuate a sprinkler 105 in the target zone 220. If the sprinklers 105 in the area outside the target zone 230 are also EAS, then the controller 210 can also provide a hold command to the sprinklers 105 in the area outside the target zone 230. If the third signal is from the area outside the target zone 230, then the commands would be reversed. The controller 210 can be programmed to require any number of input signals before providing a command, and can be programmed to receive signals in a specific order before providing a command.

In another example, act 515 can include the controller 210 receiving at least two consecutive input signals from detectors 205 disposed in the same zone before providing a command at act 520. For example, if controller 210 receives a first input signal from a first detector 205 disposed in the target zone 220, a second input signal from a second detector 205 disposed in the area outside the target zone 230, and a third input signal from a third detector 205 disposed in the target zone 220, the controller 210 can be programmed to remain inactive and not provide a command since the origin of the input signals keeps alternating. If controller 210 receives a fourth input signal from a fourth detector 205 disposed in the target zone 220, the controller 210 can now send an actuation command to the sprinklers 105 in the target zone 230 since the controller 210 now received two consecutive input signals originating in the target zone 220. If the fourth input signal is from a fourth detector 205 disposed in the area outside the target zone 230, the controller 210 can remain inactive. This process can continue until two consecutive input signals are from detectors 205 disposed in the same zone. Alternatively, after receiving a certain number of signals from alternating zones, the controller 210 can be programmed to either provide a hold command or an actuate command to desired sprinklers 105.

The signal, the origination of the signal, the number of signals, and the time between signals are all factors that help the controller 210 determine where the event (e.g., a fire) actually is in the occupancy. After the controller 210, via the processing component 415, processes those factors, at act 520 the controller 210 can provide a command to control the actuation of electronically activated sprinklers. The command can be sent to a detector 205, and then the detector 205 can send the command to the desired sprinkler 105, or the command can be sent directly to the desired sprinkler 105. For example, referring to FIG. 2, when a fire originates in the area outside the target zone 230, the threshold moment in fire growth can be detected first by detector 205 in the area outside the target zone 230. Determining that the signal came from the detector 205 in the area outside the target zone 230, the controller 210 can send a hold command to the sprinkler 105 inside the target zone 220 to at least temporarily inhibit the sprinkler 105 in the target zone 220 from actuation since the fire is likely not in the target zone 220. For example, the hold command can cause the sprinkler 105 to remain inactive for a predetermined period of time (e.g., ten minutes, two hours), or until certain predetermined parameters are met (e.g., a certain temperature threshold is reached). If the sprinkler 105 in the area outside the target zone 230 is also part of an EAS system, then the controller 210 can send an activation command telling the sprinkler 105 in the area outside the target zone 230 (associated with the detector) to actuate. If the sprinkler 105 in the area outside the target zone 230 is a non-EAS, the controller 210 has no control over when the sprinkler 105 actuates, or if it actuates at all. Actuation of the non-EAS will depend on the activation element of the sprinkler 105 and whether the threshold moment associated with the activation element is reached.

Providing a command at act 520 can also include disabling, at least temporarily, certain sprinklers 105 or detectors 205. For example, if a hold command is provided to sprinkler 105 inside the target zone 220 (e.g., an EAS), that sprinkler 105 can be inhibited from actuating until the controller 210 or the fire suppression system 200 is reset. This ensures that if the controller 210 determines, based on the parameters provided to the programming component 410, that the fire detected is outside the target zone 220, the sprinklers 105 in the target zone 220 do not actuate and pull fire suppressant fluid 120 and pressure from the sprinkler system 100 to the target zone 220 when it is needed in a different zone. For example, after providing a hold command to an EAS 105 in the target zone 220, even if a detector 205 in the target zone 220 later detects a fire and sends a signal to the controller 210, the EAS 105 will not actuate. Alternatively, the controller 210 can disable the detector 205 so the detector 205 cannot detect any more changes in the environment. Disabling the sprinkler 105 or the detector 205 in the target zone 220 until the fire suppression system 200 resets can facilitate reducing the size of the barrier 240. For example, if the controller 210 is programmed to send the sprinkler 105 in the target zone 220 a hold command if the first signal received by the controller 210 comes from the detector 205 from the area outside the target zone 230 (regardless of the time between signals), as long as the barrier 240 delays the migration of the heat or smoke into the target zone by one second, the controller 210 will still provide the hold command to the sprinkler 105 in the target zone 220. Therefore, the size of the barrier 240 can be reduced since the barrier 240 can be designed to only delay the migration rather than completely prevent the migration.

The hold command can also be a more temporary inhibition of the sprinkler 105 or the detector 205 that can be overridden by successive commands and does not require a system reset to become active again. For example, acts 510-520 can be repeated periodically during an event, and depending on the signals received by the controller 210, the controller 210 can send additional hold commands or can override the hold commands with a new actuate command. The new actuate command can be provided if the signals received by the controller 210 match a predetermined threshold provided to the programming component 410 of the controller 210. For example, if the programming component 410 is given instructions to only activate a sprinkler 105 in the target zone 220 if the detected rate of heat rise reaches 10° F./minute and the controller 210 receives a first signal indicating a rate of heat rise of only 5° F./minute, the controller 210 can provide an initial hold command. If the controller 210 then receives a second signal indicating a rate of heat rise of 12° F./minute, the controller 210 can send an actuate command, overriding the prior hold command, and cause the sprinkler 105 to actuate. Alternatively, if the second signal also does not reach the threshold provided in the instructions, the controller 210 can provide another hold command. The controller 210 can continue to receive subsequent signals (e.g., third signal, fourth signal, etc.) and can provide commands accordingly (e.g., third command, fourth command, etc.). If the threshold is ever met, the controller 210 can provide an actuate command to override the previous hold commands.

If a system reset is required to remove the hold command from the sprinkler 105, the fire suppression system 200 can be reset either manually or automatically. A manual reset can require an operator to provide an input to the fire suppression system (e.g., flip a switch, provide an override command to the controller). The automatic reset can be based on the controller 210 having predetermined thresholds that have to be met in order to reset. For example, the controller 210 can be programmed to reset if a certain period of time has elapsed since receiving the signal from the detector 205 (e.g., resets two hours after receiving a first signal), if there is no longer a threshold moment detected in the target zone 220 (e.g., rate of heat rise is 0° F./min), if there is no longer a threshold moment detected in the area outside the target zone 230 (e.g., temperature is less than 155° F.), or any combination thereof (e.g., all three parameters above must be met). Other predetermined metrics can be programmed in the programming component 410 of controller 210, and when met, can cause the fire suppression system 200 to reset and be ready to respond to the next event.

The controller 210 can function as described herein with any EAS system, including multiple EAS systems. For example, if an occupancy has a first EAS system protecting an ASRS in the target zone 220 and a second EAS system protecting other storage structures 215 in the area outside the target zone 230, the controller 210 can provide commands to either or both EAS systems according to the parameters, criteria, and rules provided to the programming component 410. If there is a non-EAS system, the controller 210 has no control over if and when the non-EAS system activates.

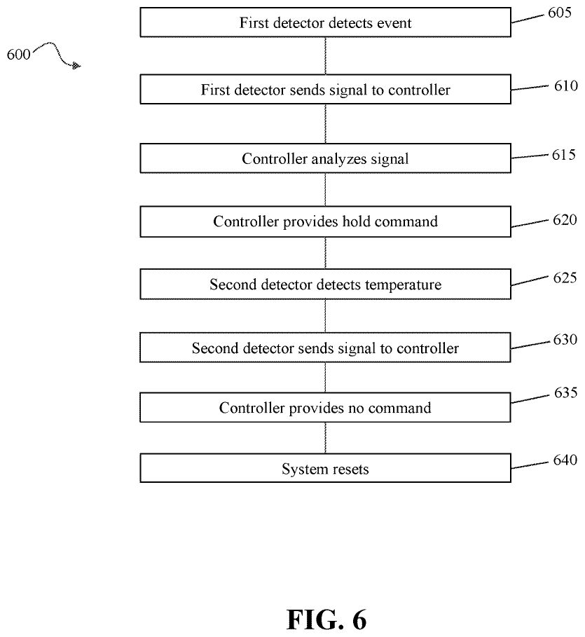

FIG. 6 depicts a flow diagram of an example fire suppression method 600 for when a fire originates in the area outside the target zone 230 and the fire suppression system 200 in the target zone 220 is an EAS system that requires a reset once a hold command is provided. At act 605, a first detector 205 detects an event. For example, the first detector 205 can be in the area outside the target zone 230. The first detector can detect a temperature (or any other condition indicative of a fire) that is above a predetermined threshold. For example, a predetermined threshold temperature can be a temperature that is indicative of a fire (e.g., 155° F.) and the detected temperature can be anything equal to or above that predetermined temperature (e.g., 160° F.).

At act 610, the first detector 205 can send a signal to the controller 210. For example, if the temperature detected is above the predetermined threshold temperature, the first detector 205 can send a signal to the controller 210 indicating the temperature detected was above 155° F. The signal can be sent to the controller 210 from the first detector 205 via the connection 235 (e.g., wired or wireless communication).

At act 615, the controller 210 can analyze the signal received at act 610. For example, the controller 210 can process the signal via the processing component 415 and compare the detected temperature with the predetermined threshold temperature. If the detected temperature is higher than the threshold temperature, the controller 210 can determine a fire is present. The controller can also determine the location of the fire. For example, if the first detector 205 is disposed in the area outside the target zone 230, the controller 210 can determine that the fire is in the area outside the target zone 230.

At act 620, the controller 210 can provide a hold command. For example, responsive to the controller 210 determining the fire is in the area outside the target zone 230, the sprinklers 105 in the target zone do not need to actuate. As such, the controller 210 can provide a hold command to the sprinklers 105 disposed in the target zone 220, inhibiting those sprinklers 105 from actuating. The hold command can prevent the sprinklers 105 in the target zone 220 from actuating at any point during the fire. For example, even if a detector 205 in the target zone 220 detects a temperature above the predetermined threshold temperature after the controller 210 provided the hold command, the sprinklers 105 in the target zone will remain inactive and not actuate (as described in acts 625-635).

At act 625, a second detector 205 detects a temperature. For example, the second detector 205 can be in the target zone 220. The detected temperature can be above a predetermined threshold temperature. For example, the predetermined threshold temperature can be a temperature that is indicative of a fire (e.g., 155° F.) and the detected temperature can be anything equal to or above that predetermined temperature (e.g., 160° F.).

At act 630, the second detector 205 can send a signal to the controller 210. For example, if the temperature detected is above the predetermined threshold temperature, the second detector 205 can send a signal to the controller 210 indicating the temperature detected was above 155° F. The signal can be sent to the controller 210 from the second detector via the connection 235 (e.g., wired or wireless communication).

At act 635, the controller 210 can provide no command. For example, as described in act 620, the previously provided hold command can inhibit the sprinklers 105 in the target zone 220 from actuating at any point during the fire. In fire suppression method 600, the fire suppression system 200 in the target zone 220 is an EAS system that requires a reset once a hold command is provided before a hold command can be overridden. As such, since the controller 210 provided the hold command at act 620 to the sprinklers 105 disposed in the target zone 220, the controller 210 cannot provide any further commands to the sprinklers 105 disposed in the target zone 220 until the fire suppression system 200 resets.

At act 640, the fire suppression system 200 can reset. For example, the controller 210 can be configured to reset the fire suppression system 200 and revert all components of the fire suppression system 200 back to their original settings (e.g., remove the hold command from the sprinklers 105 in the target zone 220 to be ready to actuate if another fire begins). For example, the controller 210 can be provided instructions via the programming component 410 to reset when the first detector 205 no longer detects a temperature above the predetermined threshold temperature, when the second detector 205 no longer detects a temperature above the predetermined threshold temperature, and it has been at least one hour since the controller 210 received the first signal. When all three of those parameters are met, the controller 210 can reset the fire suppression system 200 to its original state to be ready to respond to the next fire.

In an example where the EAS system does not require a reset after a hold command is provided, the same methodology 600 can be followed, except at act 635 the controller 210 can provide a command, either another hold command or an actuate command. Which command can be based, at least in part, on the same predetermined threshold as in acts 605 and 625, or there can be a different predetermined threshold that the second detector needs to detect in order to override the original hold command. In this example, the controller 210 can continue to receive signals from the first detector 205 and the second detector 205 and provide commands accordingly until the detectors no longer detect the fire.

Furthermore, if the controller 210 receives a first signal from the detector 205 in the target zone 220 prior to or in the absence of receiving a signal from the detector 205 in the area outside the target zone 230, the controller 210 can send an actuation signal to the sprinkler 105 in the target zone 220 or to a detector 205 associated with the sprinkler 105 in the target zone 220. Alternatively, if no hold command has been provided to the detectors 205 or the sprinklers 105 in the target zone, if a detector 205 in the target zone detects a threshold moment, the detectors 205 can automatically actuate the sprinklers 105. Receiving the first signal from a detector 205 in the target zone 220 indicates that a fire is in the target zone 220, and therefore the sprinkler 105 in the target zone 220 can actuate. If the sprinkler system 100 in the area outside the target zone 230 is also an EAS system, the controller 210 can send commands (e.g., a hold command) to the sprinklers 105 disposed in the area outside the target zone 230 in a similar manner as described in fire suppression method 600 for the EAS system in the target zone 220.

Having now described some illustrative implementations, it is apparent that the foregoing is illustrative and not limiting, having been presented by way of example. In particular, although many of the examples presented herein involve specific combinations of method acts or system elements, those acts and those elements can be combined in other ways to accomplish the same objectives. Acts, elements and features discussed in connection with one implementation are not intended to be excluded from a similar role in other implementations or implementations.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular can also embrace implementations including a plurality of these elements, and any references in plural to any implementation or element or act herein can also embrace implementations including only a single element. References in the singular or plural form are not intended to limit the presently disclosed systems or methods, their components, acts, or elements to single or plural configurations. References to any act or element being based on any information, act or element can include implementations where the act or element is based at least in part on any information, act, or element.

Any implementation disclosed herein can be combined with any other implementation or embodiment, and references to “an implementation,” “some implementations,” “one implementation” or the like are not necessarily mutually exclusive and are intended to indicate that a particular feature, structure, or characteristic described in connection with the implementation can be included in at least one implementation or embodiment. Such terms as used herein are not necessarily all referring to the same implementation. Any implementation can be combined with any other implementation, inclusively or exclusively, in any manner consistent with the aspects and implementations disclosed herein.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Systems and methods described herein may be embodied in other specific forms without departing from the characteristics thereof. Further relative parallel, perpendicular, vertical or other positioning or orientation descriptions include variations within +/−10% or +/−10 degrees of pure vertical, parallel or perpendicular positioning. References to “approximately,” “about” “substantially” or other terms of degree include variations of +/−10% from the given measurement, unit, or range unless explicitly indicated otherwise. Coupled elements can be electrically, mechanically, or physically coupled with one another directly or with intervening elements. Scope of the systems and methods described herein is thus indicated by the appended claims, rather than the foregoing description, and changes that come within the meaning and range of equivalency of the claims are embraced therein.

The term “coupled” and variations thereof includes the joining of two members directly or indirectly to one another. Such joining may be stationary (e.g., permanent or fixed) or moveable (e.g., removable or releasable). Such joining may be achieved with the two members coupled directly with or to each other, with the two members coupled with each other using a separate intervening member and any additional intermediate members coupled with one another, or with the two members coupled with each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References to “or” may be construed as inclusive so that any terms described using “or” may indicate any of a single, more than one, and all of the described terms. References to at least one of a conjunctive list of terms may be construed as an inclusive OR to indicate any of a single, more than one, and all of the described terms. For example, a reference to “at least one of ‘A’ and ‘B’” can include only ‘A’, only ‘B’, as well as both ‘A’ and ‘B’. Such references used in conjunction with “comprising” or other open terminology can include additional items.

Modifications of described elements and acts such as variations in sizes, dimensions, structures, shapes and proportions of the various elements, values of parameters, mounting arrangements, use of materials, colors, orientations can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes and omissions can also be made in the design, operating conditions and arrangement of the disclosed elements and operations without departing from the scope of the present disclosure.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

The systems and methods described herein may be embodied in other specific forms without departing from the characteristics thereof. The foregoing implementations are illustrative rather than limiting of the described systems and methods. Scope of the systems and methods described herein is thus indicated by the appended claims, rather than the foregoing description, and changes that come within the meaning and range of equivalency of the claims are embraced therein.

What we claim is:

1. A fire suppression system, comprising:
an electronically activated sprinkler (EAS) interlock system to protect a target zone, the EAS interlock system comprising:
a controller communicably coupled with a first detector and a second detector, the first detector disposed in an area outside the target zone and the second detector disposed inside the target zone, the controller to:
receive an input signal from the first detector indicating an event occurred prior to or in an absence of receipt of an input signal from the second detector indicating the event occurred; and
provide, responsive to receipt of the input signal from the first detector indicating the event occurred, a hold command to at least temporarily inhibit a sprinkler inside the target zone from actuation based on receipt of the input signal from the first detector prior to or in the absence of receipt of the input signal from the second detector.

2. The system of claim 1, comprising:
the controller to provide the hold command to the second detector, the second detector communicably coupled with the sprinkler inside the target zone, the second detector to provide the hold command to the sprinkler.

3. The system of claim 1, comprising:
the controller to provide the hold command to the sprinkler inside the target zone.

4. The system of claim 1, comprising:
the first detector and the second detector are smoke detectors.

5. The system of claim 1, comprising:
the EAS interlock system is a first EAS system;
a second EAS system to protect the area outside the target zone.

6. The system of claim 1, comprising:
a non-electronically activated sprinkler system to protect the area outside the target zone.

7. The system of claim 1, comprising:
a barrier that defines a perimeter of the target zone.

8. The system of claim 1, comprising:
the second detector communicably coupled with the sprinkler inside the target zone;
the controller, responsive to receipt of the input signal from the first detector indicating the event occurred prior to receipt of the input signal from the second detector indicating the event occurred, to provide the hold command to the second detector to at least temporarily inhibit the sprinkler from actuation.

9. The system of claim 1, comprising:
the second detector communicably coupled with the sprinkler inside the target zone;
the controller, responsive to receipt of the input signal from the first detector indicating the event occurred in the absence of receipt of the input signal from the second detector indicating the event occurred, to provide the hold command to the second detector to at least temporarily inhibit the sprinkler from actuation.

10. The system of claim 1, comprising:
the hold command, to inhibit the sprinkler from actuation until the fire suppression system resets, the fire suppression system resets upon at least one of a passing of a predetermined amount of time from receipt of the input signal from the first detector, the first detector indicating no event is occurring in the area outside the target zone, and the second detector indicating no event is occurring in the target zone.

11. The system of claim 1, comprising:
the hold command, to inhibit the sprinkler from actuation until the fire suppression system resets, the fire suppression system resets upon a passing of a predetermined amount of time since receipt of the input signal from the first detector, the first detector indicating no event is occurring in the area outside the target zone, and the second detector indicating no event is occurring in the target zone.

12. The system of claim 1, comprising:
the controller, responsive to receiving the input signal from the second detector, to provide a second hold command to continue to inhibit the sprinkler inside the target zone from actuation.

13. The system of claim 1, comprising:
the controller, responsive to receiving the input signal from the second detector, to provide a second command to override the hold command and actuate the sprinkler disposed inside the target zone.

14. The system of claim 1, comprising:
the controller, responsive to receiving a first input signal from the second detector, to provide a second hold command to continue to inhibit the sprinkler inside the target zone, and responsive to receiving a second input signal from the second detector, to provide a third command to override the second hold command and actuate the sprinkler disposed in the target zone.

15. A fire suppression method, comprising:
receiving, by a controller, an input signal from a first detector indicating an event occurred prior to or in an absence of an input signal from a second detector indicating the event occurred; and
providing, by the controller, a hold command to at least temporarily inhibit a sprinkler disposed inside a target zone from actuation based on receipt of the input signal from the first detector prior to or in the absence of the input signal from the second detector.

16. The method of claim 15, comprising:
providing the hold command to the second detector, the second detector communicably coupled with the sprinkler inside the target zone, the second detector to provide the hold command to the sprinkler.

17. The method of claim 15, comprising:
providing the hold command to the sprinkler inside the target zone.

18. The method of claim 15, comprising:
installing an electronically activated sprinkler system inside the target zone.

19. The method of claim 15, comprising:
interlocking a first electronically activated sprinkler system with a second electronically activated sprinkler system, the first electronically activated sprinkler system to protect the target zone and the second electronically activated sprinkler system to protect an area outside the target zone.

20. A fire suppression system, comprising:
an electronically activated sprinkler (EAS) interlock system to protect a target zone, the EAS interlock system comprising:
a first sprinkler connected with piping, the first sprinkler disposed in the target zone;
a first detector disposed in an area outside the target zone; and
a second detector disposed in the target zone, the second detector communicably coupled with the first sprinkler;
a non-electronically activated sprinkler (non-EAS) system to protect the area outside the target zone, the non-EAS system comprising:
a second sprinkler connected with the piping, the second sprinkler disposed in the area outside the target zone;
a barrier to define a perimeter of the target zone; and
a controller communicably coupled with the first detector and the second detector; the controller to:
receive an input signal from the first detector indicating an event occurred prior to or in an absence of receipt of an input signal from the second detector indicating the event occurred; and
provide, responsive to receipt of the input signal from the first detector indicating the event occurred, a hold command to at least temporarily inhibit the first sprinkler from actuation based on receipt of the input signal from the first detector prior to or in the absence of receipt of the input signal from the second detector.
